(19) United States
(12) Patent Application Publication
(10) Pub. No.: US 2025/0346692 A1
(43) Pub. Date: Nov. 13, 2025

(54) Transparent Articles Including a Layer Formed From an Ammonium (Meth)Acrylate Monomer

(71) Applicant: Vitro Flat Glass LLC, Cheswick, PA (US)

(72) Inventor: Dylan Thomas Christiansen, Pittsburgh, PA (US)

(21) Appl. No.: 19/192,420

(22) Filed: Apr. 29, 2025

Related U.S. Application Data
(60) Provisional application No. 63/643,960, filed on May 8, 2024.

(51) Int. Cl. C08F 20/34; E06B 3/67

(52) U.S. Cl. CPC C08F 20/34; E06B 3/6722

(57) ABSTRACT

The present invention relates to a transparent article that includes first and second transparent substrates that are opposed to each other and which together define a cavity there-between. The transparent article further includes a transparent layer that resides within the cavity. The transparent layer is formed from (e.g., by polymerization of) a polymerizable monomer composition that includes an ammonium (meth)acrylate monomer represented by the following Formula (I),

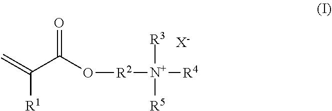

With reference to Formula (I): R¹ is hydrogen or methyl; R² is a divalent aliphatic group; R³, R⁴, and R⁵ are each independently an aliphatic group; and X⁻ is selected from halide, perchlorate, hexafluorophosphate, and bis(perfluoroalkyl) sulfonamide. The present invention also relates to a method of forming a transparent article.

### CROSS-REFERENCE TO RELATED APPLICATION

This application is entitled to and claims priority to U.S. Provisional Patent Application No. 63/643,960 which was filed on May 8, 2024, the disclosure of which is incorporated herein by reference in its entirety.

### FIELD

The present invention relates to transparent articles, that include opposed first and second transparent substrates that together define a cavity, and a transparent layer residing within the cavity, where the transparent layer is formed from a polymerizable monomer composition that includes an ammonium (meth)acrylate monomer.

### BACKGROUND

Transparent articles, such as architectural transparencies, that are resistant to impacts and/or shattering typically include a polymer layer that is interposed between two outer transparent substrates, which can be referred to as a polymer interlayer. In many applications, the polymer interlayer includes a thermoplastic polymer, such as thermoplastic polyvinyl butyral or thermoplastic polyurethane. The formation of a transparency having a thermoplastic polymer as an interlayer between two outer transparent substrates, typically involves a time and energy intensive process, such as an autoclave lamination process, which can be difficult to automate. In addition, thermoplastic interlayers are typically thick, such as having a thickness of at least 0.75 mm. The combination of a time and energy intensive lamination process, difficulty of automation, and a relatively thick interlayer can undesirably increase the costs associated with forming such laminated transparent articles.

It would be desirable to develop new multilayer transparent articles, and methods of forming such, that do not require a thermoplastic polymer interlayer, and the time and energy intensive processes associated with the formation thereof. It would be further desirable that methods of forming such new multilayer transparent articles can be at least partially automated.

### SUMMARY

In accordance with the present invention, there is provided a transparent article comprising: (a) a first transparent substrate; (b) a second transparent substrate where the first transparent substrate and the second transparent substrate are opposed to each other and define a cavity there-between; and (c) a transparent layer residing within said cavity. The transparent layer is formed from (such as by polymerization of) a polymerizable monomer composition comprising an ammonium (meth)acrylate monomer represented by the following Formula (I),

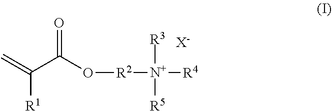

With reference to Formula (I): R¹ is hydrogen or methyl; R² is a divalent aliphatic group; R³, R⁴, and R⁵ are each independently an aliphatic group; and X⁻ is an anion selected from halide, perchlorate, hexafluorophosphate, and bis(perfluoroalkyl) sulfonimide.

In accordance with the present invention, there is further provided a method of forming a transparent article comprising: (i) providing a first transparent substrate and a second transparent substrate, wherein the first transparent substrate and the second transparent substrate are opposed to each other and define a cavity there-between; (ii) introducing a polymerizable monomer composition into the cavity, wherein the polymerizable monomer composition comprises an ammonium (meth)acrylate monomer represented by Formula (I) shown above, where R¹ through R⁵ and X⁻ are each independently as described above; and (iii) polymerizing the polymerizable monomer composition within the cavity, thereby forming a transparent layer within the cavity, wherein the transparent layer is interposed between the first transparent substrate and the second transparent substrate.

The features that characterize the present invention are pointed out with particularity in the claims, which are annexed to and form a part of this disclosure. These and other features of the invention, its operating advantages and the specific objects obtained by its use will be more fully understood from the following detailed description in which non-limiting embodiments of the invention are illustrated and described.

### BRIEF DESCRIPTION OF THE DRAWING

FIG. 1 is a representative side elevational sectional view of a transparent article according to the present invention.

### DETAILED DESCRIPTION

As used herein, the articles “a,” “an,” and “the” include plural referents unless otherwise expressly and unequivocally limited to one referent.

Unless otherwise indicated, all ranges or ratios disclosed herein are to be understood to encompass any and all subranges or subratios subsumed therein. For example, a stated range or ratio of “1 to 10” should be considered to include any and all subranges between (and inclusive of) the minimum value of 1 and the maximum value of 10; that is, all subranges or subratios beginning with a minimum value of 1 or more and ending with a maximum value of 10 or less, such as but not limited to, 1 to 6.1, 3.5 to 7.8, and 5.5 to 10.

As used herein, unless otherwise indicated, left-to-right representations of linking groups, such as divalent linking groups, are inclusive of other appropriate orientations, such as, but not limited to, right-to-left orientations. For purposes of non-limiting illustration, the left-to-right representation of the divalent linking group

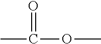

or equivalently —C(O)O—, is inclusive of the right-to-left representation thereof,

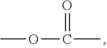

or equivalently —O(O)C— or —OC(O)—.

Other than in the operating examples, or where otherwise indicated, all numbers expressing quantities of ingredients, reaction conditions, and so forth used in the specification and claims are to be understood as modified in all instances by the term “about.”

As used herein, molecular weight values of polymers, such as weight average molecular weights (Mw) and number average molecular weights (Mn), are determined by gel permeation chromatography using appropriate standards, such as polystyrene standards.

As used herein, polydispersity index (PDI) values represent a ratio of the weight average molecular weight (Mw) to the number average molecular weight (Mn) of the polymer (i.e., Mw/Mn).

As used herein, the term “polymer” means homopolymers (e.g., prepared from a single monomer species), copolymers (e.g., prepared from at least two monomer species), and graft polymers.

As used herein, the term “(meth)acrylate” and similar terms, such as “(meth)acrylic acid ester” means methacrylates and/or acrylates. As used herein, the term “(meth)acrylic acid” means methacrylic acid and/or acrylic acid.

As used herein the term “window” means an aperture adapted to permit the transmission of radiation there-through. Non-limiting examples of windows include automotive and aircraft transparencies, windshields, filters, shutters, and optical switches.

As used herein the term “mirror” means a surface that specularly reflects a large fraction of incident light.

As used herein, spatial or directional terms, such as “left”, “right”, “inner”, “outer”, “above”, “below”, and the like, relate to the invention as it is depicted in the drawing figures. It is to be understood, however, that the invention can assume various alternative orientations and, accordingly, such terms are not to be considered as limiting.

As used herein, the terms “formed over,” “deposited over,” “provided over,” “applied over,” residing over,” or “positioned over,” mean formed, deposited, provided, applied, residing, or positioned on but not necessarily in direct (or abutting) contact with the underlying element, or surface of the underlying element. For example, a layer “positioned over” a substrate does not preclude the presence of one or more other layers, coatings, or films of the same or different composition located between the positioned or formed layer and the substrate.

As used herein, the terms “interposed” and “interposed between,” means residing or positioned between, but not necessarily in direct (or abutting) contact with overlying and/or underlying elements, or surfaces thereof. For example, a layer “interposed between” a first substrate and a second substrate does not preclude the presence of one or more other layers, coatings, or films of the same or different composition located between the interposed layer and the first and/or second substrates.

As used herein, the term “actinic radiation” means electromagnetic radiation that is capable of causing a response in a material, such as, but not limited to, activating a polymerization initiator or catalyst. Non-limiting examples of actinic radiation include ultraviolet light (UV light) and visible light.

All documents, such as but not limited to issued patents and patent applications, referred to herein, and unless otherwise indicated, are to be considered to be “incorporated by reference” in their entirety.

As used herein, the term “aliphatic group” means a non-aromatic group that can be linear or cyclic, and which can be saturated (having no carbon-carbon unsaturated groups) or unsaturated (including at least one carbon-carbon unsaturated group selected from carbon-carbon double bond unsaturated groups or carbon-carbon triple bond unsaturated groups). Aliphatic groups can include at least one heteroatom, such as oxygen, sulfur, and/or nitrogen. With some embodiments, as used herein, aliphatic groups are free of heteroatoms, and include only carbon and hydrogen. In addition, as used herein, the term aliphatic group includes linear aliphatic groups and cyclic aliphatic groups (or cycloaliphatic groups). As used herein, and in accordance with some embodiments, classes of aliphatic groups include: linear or branched alkyl groups; and cycloalkyl groups.

As used herein, recitations of “linear or branched” groups, such as linear or branched alkyl, include: a methylene group or a methyl group; groups that are linear, such as linear C₂-C₂₀ alkyl groups; and groups that are appropriately branched, such as branched C₃-C₂₀ alkyl groups.

The term “alkyl” as used herein means linear or branched, cyclic or acyclic C₁-C₂₅ alkyl. Linear or branched alkyl can include C₁-C₂₅ alkyl, such as C₁-C₂₀ alkyl, such as C₂-C₁₀ alkyl, such as C₁-C₁₂ alkyl, such as C₁-C₆ alkyl. Examples of alkyl groups from which the various alkyl groups of the present invention can be selected from, include, but are not limited to, those recited further herein. Alkyl groups can include “cycloalkyl” groups. The term “cycloalkyl” as used herein means groups that are appropriately cyclic, such as, but not limited to, C₃-C₁₂ cycloalkyl (including, but not limited to, cyclic C₃-C₁₀ alkyl, or cyclic C₅-C₇ alkyl) groups. Examples of cycloalkyl groups include, but are not limited to, those recited further herein. The term “cycloalkyl” as used herein also includes: bridged ring polycycloalkyl groups (or bridged ring polycyclic alkyl groups), such as, but not limited to, bicyclo[2.2.1]heptyl (or norbornyl) and bicyclo[2.2.2]octyl; and fused ring polycycloalkyl groups (or fused ring polycyclic alkyl groups), such as, but not limited to, octahydro-1H-indenyl, and decahydronaphthalenyl.

The term “heterocycloalkyl” as used herein means groups that are appropriately cyclic, such as, but not limited to, C₂-C₁₂ heterocycloalkyl groups, such as C₂-C₁₀ heterocycloalkyl groups, such as C₅-C₇ heterocycloalkyl groups, and which have at least one hetero atom in the cyclic ring, such as, but not limited to, O, S, N, P, and combinations thereof. Examples of heterocycloalkyl groups include, but are not limited to, imidazolyl, tetrahydrofuranyl, tetrahydropyranyl and piperidinyl. The term “heterocycloalkyl” as used herein also includes: bridged ring polycyclic heterocycloalkyl groups, such as, but not limited to, 7-oxabicyclo[2.2.1]heptanyl; and fused ring polycyclic heterocycloalkyl groups, such as, but not limited to, octahydrocyclopenta [b] pyranyl, and octahydro-1H-isochromenyl.

The descriptions, classes, and examples provided herein with regard to alkyl groups, cycloalkyl groups, heterocycloalkyl groups, haloalkyl groups, and the like, are also applicable to alkane groups, cycloalkane groups, heterocycloalkane groups, haloalkane groups, etc., such as, but not limited to, polyvalent alkane groups, such as polyvalent alkane linking groups, such as divalent alkane linking groups.

As used herein, the term “aryl” and related terms, such as “aryl group”, means an aromatic cyclic monovalent hydrocarbon radical. As used herein, the term “aromatic” and related terms, such as “aromatic group,” means a cyclic conjugated hydrocarbon having stability (due to delocalization of pi-electrons) that is significantly greater than that of a hypothetical localized structure. Examples of aryl groups include C₆-C₁₄ aryl groups, such as, but not limited to, phenyl, naphthyl, phenanthryl, and anthracenyl.

The term “heteroaryl”, as used herein, includes, but is not limited to, C₃-C₁₈ heteroaryl, such as, but not limited to, C₃-C₁₀ heteroaryl (including fused ring polycyclic heteroaryl groups) and means an aryl group having at least one hetero atom in the aromatic ring, or in at least one aromatic ring in the case of a fused ring polycyclic heteroaryl group. Examples of heteroaryl groups include, but are not limited to, furanyl, pyranyl, pyridinyl, quinolinyl, isoquinolinyl, and pyrimidinyl.

Representative alkyl groups include, but are not limited to, methyl, ethyl, propyl, isopropyl, butyl, isobutyl, sec-butyl, tert-butyl, pentyl, neopentyl, hexyl, heptyl, octyl, nonyl and decyl. Representative alkenyl groups include, but are not limited to, vinyl, allyl, and propenyl. Representative alkynyl groups include, but are not limited to, ethynyl, 1-propynyl, 2-propynyl, 1-butynyl, and 2-butynyl. Representative cycloalkyl groups include, but are not limited to, cyclopropyl, cyclobutyl, cyclopentyl, cyclohexyl, and cyclooctyl.

As used herein, the term “halo” and related terms, such as “halo group,” “halo substituent,” “halogen group,” and “halogen substituent,” means a single bonded halogen group, such as —F, —Cl, —Br, and —I.

As used herein, recitations of “halo substituted” and related terms (such as, but not limited to, haloalkyl groups, haloalkenyl groups, haloalkynyl groups, haloaryl groups, and halo-heteroaryl groups) means a group in which at least one, and up to and including all of the available hydrogen groups thereof is substituted with a halo group, such as, but not limited to F, Cl or Br. The term “halo-substituted” is inclusive of “perhalo-substituted.” As used herein, the term perhalo-substituted group and related terms (such as, but not limited to, perhaloalkyl groups, perhaloalkenyl groups, perhaloalkynyl groups, perhaloaryl groups or perhalo-heteroaryl groups) means a group in which all of the available hydrogen groups thereof are substituted with a halo group. For purposes of non-limiting illustration: perhalomethyl is —CX₃; and perhalophenyl is —C₆X₅, where X represents one or more halo groups, such as, but not limited to F, Cl, Br, or I.

As used herein, recitations of “perfluoroalkyl” and related terms, such as perfluoroalkyl group, means an alkyl group, such as a linear or branched alkyl group, in which each all of the available hydrogen groups thereof are substituted (or replaced) with a fluoro (F—) group. Non-limiting examples of perfluoroalkyl groups include, linear or branched C₁-C₁₀ perfluoroalkyl groups, and linear or branched C₁-C₆ perfluoroalkyl groups.

As used herein, “at least one of” is synonymous with “one or more of,” whether the elements are listed conjunctively or disjunctively. For example, the phrases “at least one of A, B, and C” and “at least one of A, B, or C” each mean any one of A, B, or C, or any combination of any two or more of A, B, or C. For example, A alone; or B alone; or C alone; or A and B; or A and C; or B and C; or all of A, B, and C.

As used herein, “selected from” is synonymous with “chosen from” whether the elements are listed conjunctively or disjunctively. Further, the phrases “selected from A, B, and C” and “selected from A, B, or C” each mean any one of A, B, or C, or any combination of any two or more of A, B, or C. For example, A alone; or B alone; or C alone; or A and B; or A and C; or B and C; or all of A, B, and C.

The discussion of the present invention herein may describe certain features as being “particularly” or “preferably” within certain limitations (e.g., “preferably,” “more preferably,” or “even more preferably,” within certain limitations). It is to be understood that the invention is not limited to or by such particular or preferred limitations, but encompasses the entire scope of the disclosure.

The transparent layer of the transparent article of the present invention is formed from (by polymerizing) a polymerizable monomer composition that includes an ammonium (meth)acrylate monomer represented by Formula (I), as described previously herein. With further reference to Formula (I), and in accordance with some embodiments, R² is a divalent C₁-C₆ alkyl group, or a divalent C₅-C₇ cycloalkyl group. In accordance with some further embodiments, R³, R⁴, and R⁵, of Formula (I), are each independently a linear or branched C₁-C₆ alkyl group, or a C₅-C₇ cycloalkyl group.

In accordance with some embodiments, the bis(perfluoroalkyl) sulfonamide, from which X can be selected, is a bis(linear or branched C₁-C₆ perfluoroalkyl) sulfonamide, such as bis(trifluoromethyl) sulfonamide. With some further embodiments, X⁻ of Formula (I) is selected from fluoride (F⁻), chloride (Cl⁻), bromide (Br⁻), or iodide (I⁻).

In accordance with some embodiments, in addition to the ammonium (meth)acrylate monomer represented by Formula (I), the polymerizable monomer composition further includes a comonomer, where the comonomer includes at least one of: linear or branched alkyl (meth)acrylate; cycloalkyl (meth)acrylate; or polyfunctional monomer including at least two (meth)acrylate groups. With some embodiments, the comonomer, of the polymerizable monomer composition, is free of cation groups, such as ammonium groups.

Examples of linear or branched alkyl (meth)acrylate monomers, from which the comonomer can be selected include, but are not limited to: methyl (meth)acrylate; ethyl (meth)acrylate; n-propyl (meth)acrylate; i-propyl (meth)acrylate; linear or branched butly (meth)acrylate; linear or branched pentyl (meth)acrylate; linear or branched hexyl (meth)acrylate; linear or branched heptyl (meth)acrylate; and linear or branched octyl (meth)acrylate, such as 2-ethylhexyl (meth)acrylate.

Examples of cycloalkyl (meth)acrylate monomers, from which the comonomer can be selected include, but are not limited to: cyclopentyl (meth)acrylate; cyclohexyl (meth)acrylate; and 2-norbornyl (meth)acrylate.

Classes of polyfunctional monomers including at least two (meth)acrylate groups, from which the comonomer can be selected include, but are not limited to, polyfunctional monomers represented by the following Formula (A):

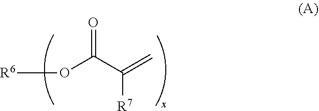

With reference to Formula (A), x is at least 2, such as from 2 to 10, or from 2 to 8, or from 2 to 6, from 2 to 4, or 2 or 3. With further reference to Formula (A), R⁷ is selected from hydrogen or methyl. With additional reference to Formula (A), R⁶ is selected from: a linear or branched alkyl group, such as linear or branched C₁-C₁₀ alkyl or linear or branched C₂-C₁₀ alkyl, optionally including at least one ether linkage (—O—) and which has a valency of x; a cycloalkyl group, such as C₃-C₁₀ cycloalkyl, having a valency of x; and combinations thereof.

Examples of polyfunctional monomer including at least two (meth)acrylate groups, include, but are not limited to: ethylene glycol di(meth)acrylate; 1,2-propylene glycol di(meth)acrylate; 1,3-propylene glycol di(meth)acrylate; 1,2-butylene glycol di(meth)acrylate; 1,3-butylene glycol di(meth)acrylate; 1,4-butylene glycol di(meth)acrylate; diethylene glycol di(meth)acrylate; triethylene glycol di(meth)acrylate; trimethylolpropane tri(meth)acrylate; pentaerythritol tetra(meth)acrylate; dipentaerythritol penta(meth)acrylate; and dipentaerythritol hexa(meth)acrylate.

With some embodiments, the comonomer includes and/or is selected from a sulfonate (meth)acrylate, such as represented by the following Formula (B):

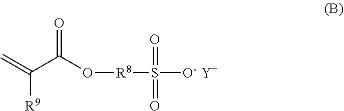

With reference to Formula (B): R⁹ is selected from hydrogen or methyl; R⁸ is a divalent aliphatic group; and Y⁺ is a cation. With some embodiments, the divalent aliphatic group R⁸ is independently selected from those classes and examples of divalent groups as described previously herein with reference to R² of Formula (I). With further reference to Formula (B), and in accordance with some embodiments, R⁸ is a divalent C₁-C₆ alkyl group, or a divalent C₅-C₇ cycloalkyl group.

With reference to Formula (B), the cation Y⁺ is selected from: one or more alkali metal cations, such as but not limited to, lithium cation, sodium cation and/or potassium cation; and/or one or more alkaline earth metal cations, such as but not limited to, magnesium cation and/or calcium cation. With some embodiments, the cation Y⁺ of Formula (B) is selected from one or more alkali metal cations, such as but not limited to, lithium cation, sodium cation, and/or potassium cation. As used herein, the term “sulfonate (meth)acrylate” refers to a monomer or comonomer represented by, and as described with reference to, Formula (B).

With some embodiments, the transparent layer is formed from a polymerizable monomer composition that includes an ammonium (meth)acrylate monomer represented by Formula (I) and a polyfunctional monomer including at least two (meth)acrylate groups, and is a crosslinked (or gelled) transparent layer, in which case the molecular weight thereof cannot be readily determined.

In accordance with some embodiments, the ammonium (meth)acrylate monomer represented by Formula (I) is present in the polymerizable composition in an amount of from 20 percent by weight to 100 percent by weight, or from 50 percent by weight to 90 percent by weight, or from 70 percent by weight to 80 percent by weight, the percent weights in each case being based on the total weight of polymerizable monomer.

With some further embodiments, if present, the comonomer is present in the polymerizable composition in an amount of from 0.1 percent by weight to 50 percent by weight, or from 1 percent by weight to 20 percent by weight, or from 5 percent by weight to 10 percent by weight, the percent weights in each case being based on the total weight of polymerizable monomer, and the balance being the amount of the ammonium (meth)acrylate monomer represented by Formula (I).

In accordance with some embodiments, the polymerizable composition includes the ammonium (meth)acrylate monomer represented by Formula (I), optionally one or more comonomers, optionally an initiator or catalyst (as described further herein), and is free of a solvent, such as an organic solvent and/or water.

Examples of organic solvents that can be included in the polymerizable compositions of the present invention include, but are not limited to, water miscible organic solvents, such as alcohols. Classes of alcohols include, but are not limited to: linear or branched alkyl alcohols having at least one alcohol group; cycloalkyl alcohols having at least one alcohol group; alkylene glycols having two alcohol groups; and poly (alkylene glycols) having two alcohol groups.

The polymerizable composition, with some embodiments, includes water. The polymerizable composition, with some further embodiments, includes water, and is free of an organic solvent. If present, water is present in the polymerizable composition in an amount of from 10 percent by weight to 40 percent by weight, or from 15 percent by weight to 30 percent by weight, the percent weights being based on total weight of the polymerizable composition.

With some embodiments, the polymerizable monomer composition is polymerized within the cavity, thereby forming the transparent layer within the cavity. When the polymerizable composition includes water and is polymerized within the cavity to form the transparent layer, it is believed, without intending to be bound by any theory, that the water acts as a plasticizer within the in situ formed transparent layer.

The transparent layer of the transparent article of the present invention, with some embodiments, has a thickness of from 0.1 mm to 5 mm, or from 0.2 mm to 3 mm, or from 0.5 mm to 2 mm.

The polymerizable monomer composition, with some embodiments, is polymerized by: exposure to actinic radiation; or exposure to elevated temperature (or thermal energy); or a combination thereof (a combination of actinic radiation and elevated temperature/thermal energy).

The polymerizable monomer composition can be polymerized in the presence of a suitable initiator, such as, but not limited to, a thermally activated free radical polymerization initiator. By “thermally activated” means the free radical initiator becomes active (or activated) at elevated temperature, such as at temperatures greater than ambient room temperature, such as greater than 25° C., such as from 25° C. to 200° C., or from 50° C. to 110° C. Classes of thermally activated free radical initiators include, but are not limited to, organic peroxy compounds, azobis(organonitrile) compounds, N-acyloxyamine compounds, O-imino-isourea compounds, and combinations of two or more thereof. With some embodiments, the themally activated free radical polymerization initiator is present in an amount of from 0.01 percent by weight to 5 percent by weight, based on the weight of polymerizable monomers.

Examples of organic peroxy compounds, that can be used as thermal polymerization initiators include, but are not limited to: peroxymonocarbonate esters, such as tertiarybutylperoxy 2-ethylhexyl carbonate and tertiarybutylperoxy isopropyl carbonate; peroxyketals, such as 1,1-di-(t-butyl peroxy)-3,3,5-trimethylcyclohexane; peroxydicarbonate esters, such as di(2-ethylhexyl) peroxydicarbonate, di(secondary butyl) peroxydicarbonate and diisopropylperoxydicarbonate; diacyperoxides, such as 2,4-dichlorobenzoyl peroxide, isobutyryl peroxide, decanoyl peroxide, lauryl peroxide, propionyl peroxide, acetyl peroxide, benzoyl peroxide, p-chlorobenzoyl peroxide; peroxyesters such as t-butylperoxy pivalate, t-butylperoxy octylate, and t-butylperoxyisobutyrate; methylethylketone peroxide, and acetylcyclohexane sulfonyl peroxide. With some embodiments, further examples of peroxy compounds from which the free radical initiator can be selected include, but are not limited to, 2,5-dimethyl-2,5-di(2-ethylhexylperoxy) hexane, and/or 1,1-bis(tert-butylperoxy)-3,3,5-trimethylcyclohexane.

Examples of azobis(organonitrile) compounds, that can be used as thermal polymerization initiators in the polymerizable monomer composition, include, but are not limited to, azobis(isobutyronitrile), 2,2′-azobis(2-methyl-butanenitrile), and/or azobis(2,4-dimethylvaleronitrile).

Further non-limiting examples thermal polymerization initiators include 1-acetoxy-2,2,6,6-tetramethylpiperidine, and/or 1,3-dicyclohexyl-O-(N-cyclohexylideneamino)-isourea.

In accordance with some embodiments, the polymerizable monomer composition, including the ammonium (meth)acrylate monomer represented by Formula (I), is polymerized by exposure to actinic radiation, such as UV light and/or visible light, in the presence of a suitable actinic light activated polymerization catalyst or initiator, which are generally referred to a photoinitiators. Classes of photoinitiators that can be used with the polymerizable monomer composition of the present invention include, but are not limited to, cleavage-type photoinitiators and abstraction-type photoinitiators. Non-limiting examples of cleavage-type photoinitiators include acetophenones, α-aminoalkylphenones (alpha-aminoalkylphenones), benzoin ethers, benzoyl oximes, acylphosphine oxides and bisacylphosphine oxides or mixtures of such initiators. Non-limiting examples of abstraction-type photoinitiators include benzophenone, Michler's ketone, thioxanthone, anthraquinone, camphorquinone, fluorone, ketocoumarin or mixtures of such initiators.

With some embodiments, the actinic light activated polymerization catalyst or initiator (or photoinitiator) is present in an amount of from 0.01 percent by weight to 5 percent by weight, based on the weight of polymerizable monomers.

Another non-limiting example of a photoinitiator that can be used with the polymerizable monomer composition of the present invention, is a visible light photoinitiator. Non-limiting examples of suitable visible light photoinitiators are set forth at column 12, line 11 to column 13, line 21 of U.S. Pat. No. 6,602,603, which disclosure is specifically incorporated by reference herein.

In accordance with some embodiments, examples of photoinitiators used with the polymerizable monomer composition of the present invention include, but are not limited to, 2,2-dimethoxy-2-phenylacetophenone and 1-hydroxycyclohexyl phenyl ketone.

The transparent article, in accordance with some embodiments of the present invention, includes a gasket (or seal) that is positioned sealingly around a periphery of the transparent article, where the first transparent substrate, the second transparent substrate, and the gasket together define the cavity. The gasket can be fabricated from any suitable material. In accordance with some embodiments, the gasket is fabricated from: a thermoplastic material; a natural rubber material; a synthetic rubber material; and/or an elastomeric material. The gasket, with some embodiments is fabricated from (or includes) an acrylic elastomeric material and/or a silicone material. In accordance with some embodiments, the gasket, in addition to sealing the cavity, also serves to define the width of the cavity, which with some embodiments is from 0.1 mm to 5 mm, or from 0.2 mm to 3 mm.

The first transparent substrate and the second transparent substrate, of the transparent article, with some embodiments, each independently include (or are each independently fabricated from): silica glass; an organic polymer (such as, but not limited to, polycarbonate polymers and/or poly(meth)acrylate polymers); or combinations thereof. With some embodiments, the transparent substrates, from which the first and second transparent substrates can each be independently selected, include (or are fabricated from) materials including silica glass. The first and second transparent substrates can each independently have any suitable thickness. With some embodiments, the first and second transparent substrates each independently have a thickness of from 1 mm to 25 mm, or from 2 mm to 10 mm.

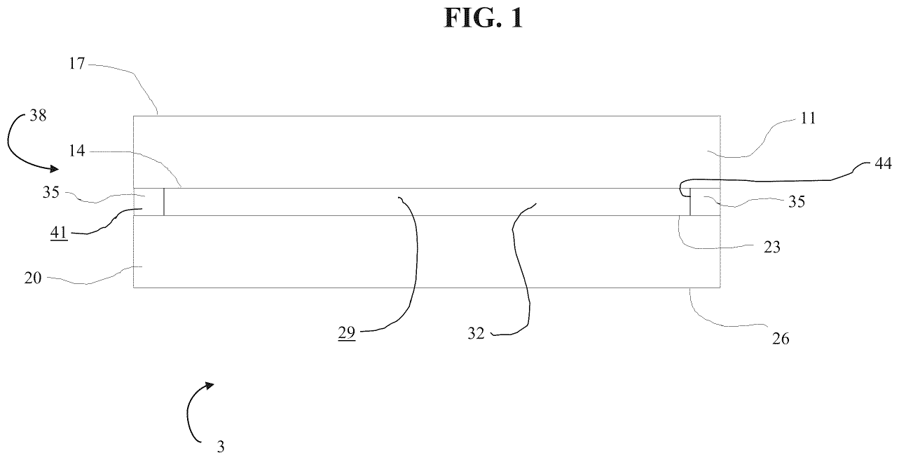

For purposes of non-limiting illustration, a transparent article (3) according to the present invention is depicted in FIG. 1. Transparent article (3) includes a first transparent substrate (11), having a first surface (14) and a second surface (17). Transparent article (3) also includes a second transparent substrate (20) having a first surface (23) and a second surface (26). Second surface (17) of first transparent substrate (11) and second surface (26) of second transparent substrate (20) each independently face an exterior of the transparent article (3), and define at least a portion of an exterior of the transparent article (3).

With further reference to FIG. 1, the first transparent substrate (11) and the second transparent substrate (20) are opposed to each other and define a cavity (29) there-between. In accordance with some embodiments, the first surface (14) of the first transparent substrate (11) and the first surface (23) of the second transparent substrate (20) are in facing spaced opposition to each other and together define cavity (29) there-between.

Transparent layer (32) resides within cavity (29), of transparent article (3). With some embodiments, transparent layer (32) resides within cavity (29) and is in abutting relationship with first surface (14) of first transparent substrate (11) and first surface (23) of second transparent substrate (20).

In accordance with some embodiments of the present invention, and with reference to FIG. 1, transparent article (3) further includes a gasket (35) that is positioned sealingly around a periphery (38) of the transparent article (3). With some embodiments, the first transparent substrate (11), the second transparent substrate (14), and the gasket (35) together define the cavity (29). With some further embodiments, the first surface (14) of the first transparent substrate (11), the first surface (23) of the second transparent substrate (20), and an interior surface (44) of gasket (35), together define the cavity (29) within which the transparent layer (32) resides.

In accordance with some embodiments, gasket (35), or at least a portion of gasket (35), resides within a recess (41) that extends around the whole of transparent article (3). Recess (41), with some embodiments, is an annular ring (41).

Examples of articles, such as articles of manufacture, that may include or be defined by the transparent articles of the present invention include, but are not limited to: architectural transparencies (or windows); transportation transparencies; and transparent protective shields. Further examples of articles, such as articles of manufacture, that may include or be defined by the transparent articles of the present invention include, but are not limited to, ophthalmic articles, such as corrective lenses, non-corrective lenses, magnifying lenses, protective lenses, visors, and face shields.

The present invention also relates to a method of forming a transparent article as described previously herein. The method of the present invention includes: (i) providing a first transparent substrate and a second transparent substrate, where the first transparent substrate and the second transparent substrate are opposed to each other and define a cavity there-between. The method further includes, (ii) introducing a polymerizable monomer composition into the cavity, where the polymerizable monomer composition includes an ammonium (meth)acrylate monomer represented by Formula (I), as described previously herein. The method additionally includes, (iii) polymerizing the polymerizable monomer composition within the cavity, thereby forming a transparent layer within the cavity, where the transparent layer is interposed between the first transparent substrate and the second transparent substrate.

In accordance with some embodiments of the method of the present invention, the first transparent substrate and the second transparent substrate each independently include (or are fabricated from) silica glass, an organic polymer, or a combination thereof, as described previously herein.

With the method of the present invention, R¹ through R⁵ and X⁻ of the ammonium (meth)acrylate monomer represented by Formula (I) are each independently as described previously herein.

The polymerizable monomer composition of the method of the present invention, with some embodiments, further includes a comonomer, where the comonomer includes at least one of, linear or branched alkyl (meth)acrylate, cycloalkyl (meth)acrylate, or polyfunctional monomer including at least two (meth)acrylate groups. The comonomers of the polymerizable composition are each independently selected from those classes and examples of comonomers as described previously herein.

In accordance with some embodiments, the polymerizable composition, of the method of the present invention, includes the ammonium (meth)acrylate monomer represented by Formula (I), optionally one or more comonomers, optionally an initiator or catalyst (as described previously herein), and is free of a solvent, such as an organic solvent and/or water.

Examples of organic solvents that can be included in the polymerizable compositions of the method of the present invention include, but are not limited to, water miscible organic solvents, such as alcohols. Classes of alcohols include, but are not limited to: linear or branched alkyl alcohols having at least one alcohol group; cycloalkyl alcohols having at least one alcohol group; alkylene glycols having two alcohol groups; and poly(alkylene glycols) having two alcohol groups.

The polymerizable monomer composition, with some embodiments of the method of the present invention, includes water. The polymerizable composition, with some further embodiments of the method of the present invention, includes water, and is free of an organic solvent.

The polymerizable monomer composition can be introduced into the cavity by any suitable art-recognized methods. With some embodiments, the polymerizable composition is poured into the cavity. With some further embodiments, the polymerizable composition is introduced into the cavity through an elongated tube, such as a syringe-like needle, that is in fluid communication with a reservoir (containing the polymerizable monomer composition) that optionally includes a metered pump, or a plunger that is manually or mechanically actuated. The polymerizable monomer composition, with some embodiments, is deaerated prior to and/or after introduction into the cavity. Deaerating the polymerizable monomer composition is achieved, with some embodiments, by exposing the polymerizable monomer composition to reduced atmosphere, such as a vacuum.

With some embodiments of the method of the present invention, the polymerizable monomer composition is introduced into the cavity so as to completely fill (or substantially completely fill) the cavity.

The method of the present invention, with some embodiments, further includes providing a gasket that extends sealingly around a periphery of the transparent article, wherein the first transparent substrate, the second transparent substrate, and the gasket together define the cavity, as described previously herein. With some embodiments, a portion of the gasket is held out of sealing engagement with a portion of the periphery of the transparent article, which provides an opening or aperture through which the polymerizable monomer composition is introduced into the cavity. After introduction of the polymerizable monomer composition into the cavity, the gasket is positioned so as to be in sealing engagement with the whole of the periphery of the transparent article.

In accordance with some embodiments of the method of the present invention, polymerizing the polymerizable monomer composition within the cavity includes exposing the polymerizable monomer composition to, actinic radiation, or elevated temperature, or a combination thereof, as described previously herein. The polymerizable monomer composition can be polymerized in the presence of a suitable initiator, such as, but not limited to: a thermally activated free radical polymerization initiator; and/or a suitable actinic light activated polymerization catalyst or initiator, (which are generally referred to a photoinitiators), each as described previously herein.

Examples of articles, such as articles of manufacture, that may include or be defined by the transparent articles prepared by the method of the present invention include, but are not limited to: architectural transparencies (or windows); transportation transparencies; and transparent protective shields, as described previously herein.

The present invention can further be characterized by one or more of the following non-limiting clauses.

Clause 1: A transparent article comprising:
(a) a first transparent substrate;
(b) a second transparent substrate, wherein said first transparent substrate and said second transparent substrate are opposed to each other and define a cavity there-between; and
(c) a transparent layer residing within said cavity,
wherein said transparent layer is formed from (such as by polymerization of) a polymerizable monomer composition comprising an ammonium (meth)acrylate monomer represented by the following Formula (I),

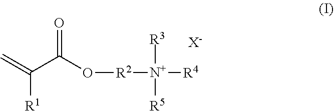

wherein independently for each ammonium (meth)acrylate monomer represented by Formula (I),
   R¹ is hydrogen or methyl,
   R² is a divalent aliphatic group,
   R³, R⁴, and R⁵ are each independently an aliphatic group, and
X⁻ is selected from halide, perchlorate, hexafluorophosphate, and bis(perfluoroalkyl) sulfonimide.

Clause 2: The transparent article of clause 1 wherein,
R² is a divalent C₁-C₆ alkyl group, or a divalent C₅-C₇ cycloalkyl group,
R³, R⁴, and R⁵ are each independently a linear or branched C₁-C₆ alkyl group, or a C₅-C₇ cycloalkyl group, and
   X⁻ is selected from fluoride, chloride, bromide, or iodide.

Clause 3: The transparent article of clause 1 or clause 2, wherein said polymerizable monomer composition further comprises a comonomer, wherein said comonomer comprises at least one of, linear or branched alkyl (meth)acrylate, cycloalkyl (meth)acrylate, polyfunctional monomer including at least two (meth)acrylate groups, or a sulfonate (meth)acrylate.

Clause 4: The transparent article of any one of clauses 1 through 3, wherein said polymerizable monomer composition further comprises water.

Clause 5: The transparent article of any one of clauses 1 through 5, wherein said polymerizable monomer composition is polymerized within said cavity, thereby forming said transparent layer within said cavity.

Clause 6: The transparent article of clause 5, wherein said polymerizable monomer composition is polymerized by, exposure to actinic radiation, or exposure to elevated temperature, or a combination thereof.

Clause 7: The transparent article of any one of clauses 1 through 6, further comprising a gasket that is positioned sealingly around a periphery of said transparent article, wherein said first transparent substrate, said second transparent substrate, and said gasket together define said cavity.

Clause 8: The transparent article of any one of clauses 1 through 7, wherein said first transparent substrate and said second transparent substrate each independently comprise, silica glass, an organic polymer, or combinations thereof.

Clause 9: The transparent article of any one of clauses 1 through 8, wherein said transparent article is selected from architectural transparencies, transportation transparencies, and transparent protective shields.

Clause 10: A method of forming a transparent article comprising:
(i) providing a first transparent substrate and a second transparent substrate, wherein said first transparent substrate and said second transparent substrate are opposed to each other and define a cavity there-between;
(ii) introducing a polymerizable monomer composition into said cavity, wherein said polymerizable monomer composition comprises an ammonium (meth)acrylate monomer represented by the following Formula (I),

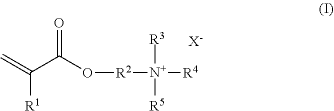

wherein independently for each ammonium (meth)acrylate monomer represented by Formula (I),
R¹ is hydrogen or methyl,
R² is a divalent aliphatic group,
R³, R⁴, and R⁵ are each independently an aliphatic group, and
X⁻ is selected from halide, perchlorate, hexafluorophosphate, and bis(perfluoroalkyl) sulfonamide; and
(iii) polymerizing said polymerizable monomer composition within said cavity, thereby forming a transparent layer within said cavity, wherein said transparent layer is interposed between said first transparent substrate and said second transparent substrate.

Clause 11: The method of clause 10 wherein,
R² is a divalent C₁-C₆ alkyl group, or a divalent C₅-C₇ cycloalkyl group,
R³, R⁴, and R⁵ are each independently a linear or branched C₁-C₆ alkyl group, or a
C₅-C₇ cycloalkyl group, and
X⁻ is selected from fluoride, chloride, bromide, or iodide.

Clause 12: The method of clause 10 or clause 11, wherein said polymerizable monomer composition further comprises a comonomer, wherein said comonomer comprises at least one of, linear or branched alkyl (meth)acrylate, cycloalkyl (meth)acrylate, or polyfunctional monomer including at least two (meth)acrylate groups.

Clause 13: The method of any one of clauses 10 through 12, wherein said polymerizable monomer composition further comprises water.

Clause 14: The method of any one of clauses 10 through 13, wherein polymerizing said polymerizable monomer composition within said cavity comprises exposing said polymerizable monomer composition to, actinic radiation, or elevated temperature, or a combination thereof.

Clause 15: The method of any one of clauses 10 through 14, wherein said method further comprises providing a gasket that extends sealingly around a periphery of said transparent article, wherein said first transparent substrate, said second transparent substrate, and said gasket together define said cavity.

Clause 16: The method of any one of clauses 10 through 15, wherein said first transparent substrate and said second transparent substrate each independently comprise silica glass, an organic polymer, or a combination thereof.

Clause 17: The method of any one of clauses 10 through 16, wherein said transparent article is selected from architectural transparencies, transportation transparencies, and transparent protective shields.

The present invention is more particularly described in the following examples, which are intended as illustrative only, since numerous modifications and variations therein will be apparent to those skilled in the art.

### EXAMPLES

In Part-1 there is described the preparation of a polymerizable monomer composition used to form a transparent layer of a transparent article according to the present invention. In Part-2 there is described the preparation of a transparent article according to the present invention.

### Part-1

A polymerizable monomer composition was formed by adding 100 g of methacroylcholine chloride (also named, trimethyl-2-methacryoyloxyethylammonium chloride) (80% by weight in water) and 300 mg of 1-hydroxycyclohexyl phenyl ketone to a 250 mL glass Erlenmeyer flask, with constant stirring provided by a magnetic stir bar. The mixed contents of the flask were then subjected to purging with nitrogen for 10 minutes, which resulted in the formation of the polymerizable monomer composition. The resulting polymerizable monomer composition was drawn into a syringe fitted with a 0.25 mm diameter needle.

### Part-2

Two plates of 4″×4″×3 mm (10.16 cm×10.16 cm×3 mm) flat clear silica glass were washed with deionized water and air dried. To the internal perimeter of a first glass plate was applied a gasket (or border) of double sided acrylic tape, having a width of 0.25 inches (6.35 mm) and a thickness of 0.5 mm, which served to set the gap between the two (first and second) glass plates and contain the polymerizable monomer composition within the cavity defined there-between. Two separate and spaced 1 mm wide ports were cut along one edge of the gasket, followed by adhering together the first and second glass plates, to form an intermediate transparent article having a cavity defined by the inner surfaces of the first and second glass plates and the gasket. The intermediate transparent article was stood vertically, so that the ports were positioned along the top (or upper) edge thereof. The polymerizable monomer composition was slowly injected into the cavity through one of the two ports. As the cavity was filled with the injected polymerizable monomer composition, air was allowed to concurrently escape from the cavity through the other port. After filling the cavity with the injected polymerizable monomer composition, ultraviolet light having a wavelength of 365 nm was passed through the glass plates, which resulted in polymerization of the polymerizable monomer composition within the cavity, and formation of a transparent layer within the cavity. After the in situ formation of the transparent layer within the cavity, the two ports were both filled with a solidifying silicone material. The so-formed transparent article was observed visually to have a desirable level of optical clarity.

The present invention has been described with reference to specific details of particular embodiments thereof. It is not intended that such details be regarded as limitations upon the scope of the invention except insofar as to the extent that they are included in the accompanying claims.

What is claimed is:

1. A transparent article comprising:
(a) a first transparent substrate;
(b) a second transparent substrate, wherein said first transparent substrate and said second transparent substrate are opposed to each other and define a cavity there-between; and
(c) a transparent layer residing within said cavity,
wherein said transparent layer is formed from a polymerizable monomer composition comprising an ammonium (meth)acrylate monomer represented by the following Formula (I), 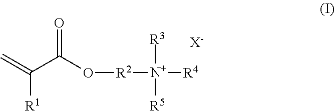
wherein independently for each ammonium (meth)acrylate monomer represented by Formula (I),
R¹ is hydrogen or methyl,
R² is a divalent aliphatic group,
R³, R⁴, and R⁵ are each independently an aliphatic group, and
X⁻ is selected from halide, perchlorate, hexafluorophosphate, and bis(perfluoroalkyl) sulfonamide.

2. The transparent article of claim 1 wherein,
R² is a divalent C₁-C₆ alkyl group, or a divalent C₅-C₇ cycloalkyl group,
R³, R⁴, and R⁵ are each independently a linear or branched C₁-C₆ alkyl group, or a
C₅-C₇ cycloalkyl group, and
X⁻ is selected from fluoride, chloride, bromide, or iodide.

3. The transparent article of claim 1, wherein said polymerizable monomer composition further comprises a comonomer, wherein said comonomer comprises at least one of, linear or branched alkyl (meth)acrylate, cycloalkyl (meth)acrylate, polyfunctional monomer including at least two (meth)acrylate groups, or a sulfonate (meth)acrylate.

4. The transparent article of claim 1, wherein said polymerizable monomer composition further comprises water.

5. The transparent article of claim 1, wherein said polymerizable monomer composition is polymerized within said cavity, thereby forming said transparent layer within said cavity.

6. The transparent article of claim 5, wherein said polymerizable monomer composition is polymerized by, exposure to actinic radiation, or exposure to elevated temperature, or a combination thereof.

7. The transparent article of claim 1, further comprising a gasket that is positioned sealingly around a periphery of said transparent article, wherein said first transparent substrate, said second transparent substrate, and said gasket together define said cavity.

8. The transparent article of claim 1, wherein said first transparent substrate and said second transparent substrate each independently comprise, silica glass, an organic polymer, or combinations thereof.

9. The transparent article of claim 1, wherein said transparent article is selected from architectural transparencies, transportation transparencies, and transparent protective shields.

10. A method of forming a transparent article comprising:
(i) providing a first transparent substrate and a second transparent substrate, wherein said first transparent substrate and said second transparent substrate are opposed to each other and define a cavity there-between;
(ii) introducing a polymerizable monomer composition into said cavity, wherein said polymerizable monomer composition comprises an ammonium (meth)acrylate monomer represented by the following Formula (I), 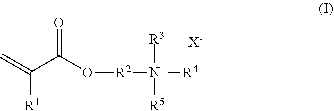
wherein independently for each ammonium (meth)acrylate monomer represented by Formula (I),
R¹ is hydrogen or methyl,
R² is a divalent aliphatic group,
R³, R⁴, and R⁵ are each independently an aliphatic group, and
X⁻ is selected from halide, perchlorate, hexafluorophosphate, and bis(perfluoroalkyl) sulfonamide; and
(iii) polymerizing said polymerizable monomer composition within said cavity, thereby forming a transparent layer within said cavity, wherein said transparent layer is interposed between said first transparent substrate and said second transparent substrate.

11. The method of claim 10 wherein,
R² is a divalent C₁-C₆ alkyl group, or a divalent C₅-C₇ cycloalkyl group,
R³, R⁴, and R⁵ are each independently a linear or branched C₁-C₆ alkyl group, or a
C₅-C₇ cycloalkyl group, and
X⁻ is selected from fluoride, chloride, bromide, or iodide.

12. The method of claim 10, wherein said polymerizable monomer composition further comprises a comonomer, wherein said comonomer comprises at least one of, linear or branched alkyl (meth)acrylate, cycloalkyl (meth)acrylate, or polyfunctional monomer including at least two (meth)acrylate groups.

13. The method of claim 10, wherein said polymerizable monomer composition further comprises water.

14. The method of claim 10, wherein polymerizing said polymerizable monomer composition within said cavity comprises exposing said polymerizable monomer composition to, actinic radiation, or elevated temperature, or a combination thereof.

15. The method of claim 10, wherein said method further comprises providing a gasket that extends sealingly around a periphery of said transparent article, wherein said first transparent substrate, said second transparent substrate, and said gasket together define said cavity.

16. The method of claim 10, wherein said first transparent substrate and said second transparent substrate each independently comprise silica glass, an organic polymer, or a combination thereof.

17. The method of claim 10, wherein said transparent article is selected from architectural transparencies, transportation transparencies, and transparent protective shields.
